(19) United States
(12) Patent Application Publication
(10) Pub. No.: US 2024/0234783 A9
(43) Pub. Date: Jul. 11, 2024

(54) APPARATUS FOR MANUFACTURING ELECTRODE ASSEMBLY

(71) Applicants: Hyundai Motor Company, Seoul (KR); Kia Corporation, Seoul (KR)

(72) Inventor: Kyung Mo KIM, Hwaseong-si (KR)

(21) Appl. No.: 18/320,381

(22) Filed: May 19, 2023

(30) Foreign Application Priority Data
Oct. 24, 2022 (KR) 1020220137127

(51) Int. Cl. H01M 10/04; H01M 4/38; H01M 10/0583

(52) U.S. Cl. CPC H01M 10/0404; H01M 4/382; H01M 10/0583; H01M 10/0525

(57) ABSTRACT

The present disclosure relates to an apparatus for manufacturing an electrode assembly. According to an implementation, the apparatus for manufacturing an electrode assembly comprises a folding unit comprising a pair of folding guides facing each other, wherein the folding guides are configured to alternately fold an electrode assembly sheet being continuously supplied to form an electrode stack having a predetermined size.

### CROSS-REFERENCE TO RELATED APPLICATION

This application claims, under 35 U.S.C. § 119(a), the benefit of and priority to Korean Patent Application No. 10-2022-0137127, filed on Oct. 24, 2022, the entire contents of which are incorporated herein by reference.

### TECHNICAL FIELD

The present disclosure relates to a battery, and more particularly, to an apparatus for manufacturing an electrode assembly of a battery cell.

### BACKGROUND

Recently, research and development of a rechargeable battery, which is being adopted in various industrial fields, such as an electronic device, an electric vehicle, and an energy storage system, is being actively conducted. A lithium-ion battery including a liquid electrolyte has been widely used, but in recent years, a next-generation battery, such as a lithium-metal battery including a solid electrolyte instead of the liquid electrolyte is attracting attention in that the same has an improved energy density.

A unit cell of a lithium-ion battery is typically manufactured in such a manner that an electrode assembly in which a positive electrode, a negative electrode, and a separator are assembled is sealed with a casing having a shape, such as a square, a pouch, or a cylinder. An electrode assembly Z1 may be manufactured as illustrated in FIG. 1A. First, a positive electrode 10 and a negative electrode 11 cut to have a predetermined area are prepared, and a separator 13 is folded to continuously have a series of Z shapes. The positive electrode 10 and the negative electrode 11 are alternately inserted in the folded separator 13, and then a so-called Z-stacked electrode assembly Z1 as illustrated in FIG. 1B may be manufactured. Thereafter, the electrode assembly Z1 is inserted into the casing through a pressing process, and then a process of manufacturing a cell is performed.

### SUMMARY OF THE DISCLOSURE

The present disclosure has been made in an effort to solve the above-described problems associated with the prior art, and it is an object of the present disclosure to provide an apparatus for manufacturing an electrode assembly and a method of operating the same that can be simplified by reducing the number of processes.

Another object of the present disclosure is to provide an apparatus for manufacturing an electrode assembly and a method of operating the same capable of manufacturing an electrode assembly at high speed without damaging an electrode or a solid electrolyte.

The objects of the present disclosure are not limited to the ones mentioned above, and other objects not mentioned herein will be clearly understood by those of ordinary skill in the art to which the present disclosure pertains (hereinafter, “those skilled in the art”) based on the description below.

In one aspect, the present disclosure provides an apparatus for manufacturing an electrode assembly. According to an implementation, the apparatus for manufacturing an electrode assembly comprises a folding unit comprising a pair of folding guides facing each other, wherein the folding guides are configured to alternately fold an electrode assembly sheet being continuously supplied to form a stack having a predetermined size.

Other aspects and preferred implementations of the disclosure are discussed infra.

It is to be understood that the term “vehicle” or “vehicular” or other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g. fuels derived from resources other than petroleum). As referred to herein, a hybrid vehicle is a vehicle that has two or more sources of power, for example, a vehicle powered by both gasoline and electricity.

The above and other features of the disclosure are discussed infra.

### BRIEF DESCRIPTION OF THE DRAWINGS

The above and other features of the present disclosure will now be described in detail with reference to certain exemplary implementations thereof illustrated in the accompanying drawings which are given hereinbelow by way of illustration only, and thus are not limitative of the present disclosure, and wherein:

FIGS. 1A and 1B illustrate an exemplary process of manufacturing an electrode assembly;

FIGS. 2A to 2D illustrate exemplary electrode assemblies manufactured according to various methods;

FIG. 3 illustrates an example electrode assembly according to the present disclosure;

FIGS. 4A to 4D illustrate an example process of manufacturing an electrode assembly sheet according to the present disclosure;

FIGS. 5A and 5B illustrate the example arrangement of a positive electrode tab and a negative electrode tab of an electrode assembly according to the present disclosure;

FIGS. 6 to 8 illustrate an example apparatus for manufacturing an electrode assembly according to an implementation of the present disclosure;

FIG. 9 shows a partially enlarged view of FIG. 7;

FIGS. 10 to 12 illustrate an example folding unit of an apparatus for manufacturing an electrode assembly according to an implementation of the present disclosure;

FIGS. 13 to 15 illustrate an example pressing unit of an apparatus for manufacturing an electrode assembly according to an implementation of the present disclosure;

FIGS. 16 and 17 illustrate an example alignment unit of an apparatus for manufacturing an electrode assembly according to an implementation of the present disclosure; and

FIG. 18 describes the example operation of a folding unit of an apparatus for manufacturing an electrode assembly according to an implementation of the present disclosure.

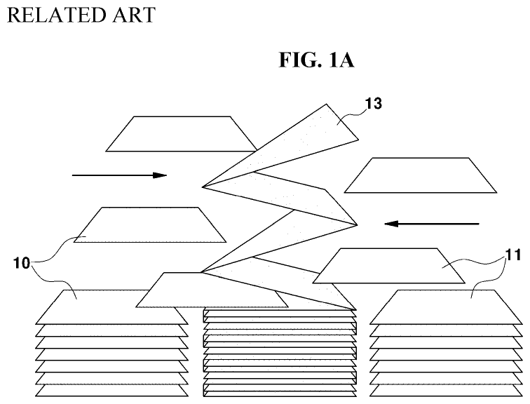

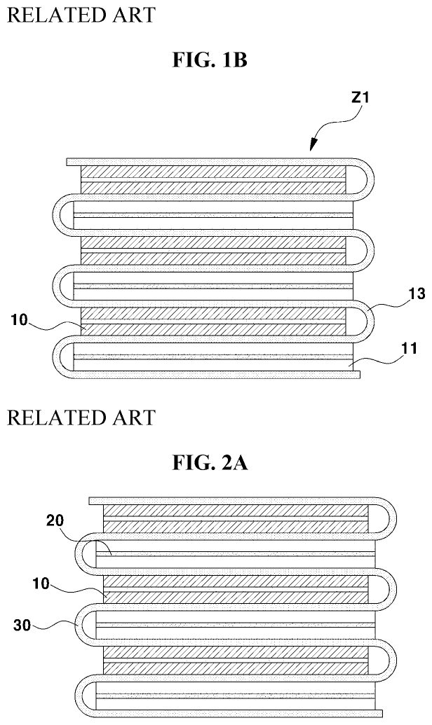

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

Descriptions of specific structures or functions presented in the implementations of the present disclosure are merely exemplary for the purpose of explaining the implementations according to the concept of the present disclosure, and the implementations according to the concept of the present disclosure may be implemented in various forms. In addition, the descriptions should not be construed as being limited to the implementations described herein, and should be understood to include all modifications, equivalents and substitutes falling within the idea and scope of the present disclosure.

Hereinafter, the present disclosure will be described in detail with reference to the accompanying drawings.

A lithium-metal battery, which is attracting attention as a next-generation battery, is a rechargeable battery in which lithium metal is applied as a negative electrode material, unlike a lithium-ion battery in which graphite or silicon is applied as a negative electrode material.

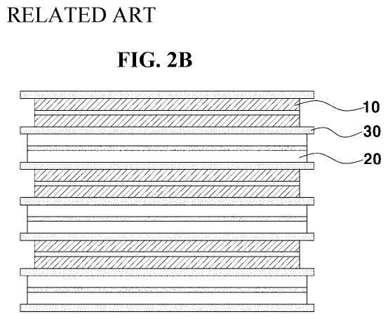

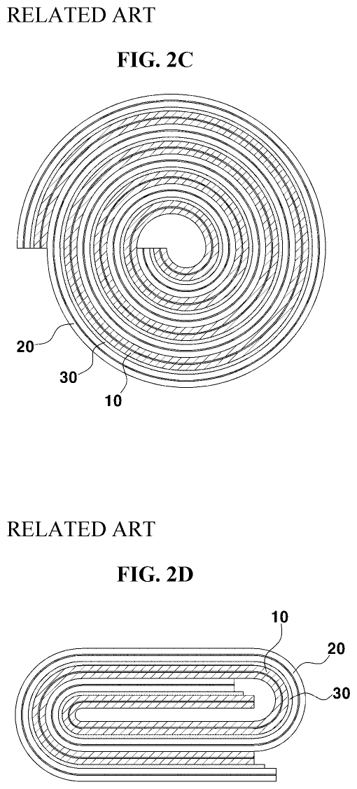

As illustrated in FIGS. 2A to 2D, a unit cell of the lithium-metal battery may be manufactured through Z-stacking like a cell of the lithium-ion battery (FIG. 2A). Alternatively, as illustrated in FIG. 2B, the unit cell of the lithium-metal battery may be manufactured using a method in which a positive electrode 10, a negative electrode (lithium-metal layer, 20), and a solid electrolyte 30 are cut to have a predetermined area and then sequentially stacked. In addition, as illustrated in FIG. 2C, the unit cell of the lithium-metal battery may be manufactured using a cylindrical winding method in which the positive electrode 10, the negative electrode 20, and the solid electrolyte 30 are stacked without cutting, then rolled into a roll shape. Alternatively, as illustrated in FIG. 2D, the unit cell of the lithium-metal battery may be manufactured using a prismatic winding method in which the positive electrode 10, the negative electrode 20, and the solid electrolyte 30 are stacked without cutting, then rolled into an oval shape having two opposing flat sides.

Reviewing the manufacturing methods discussed above, it is noted that in case of FIG. 2A or 2B, as the positive electrode 10 and the negative electrode 20 go through a cutting process, the assembly process tends to be complex. In case of FIG. 2C or 2D, there may be a dead space that cannot be used, which can lead to reduced efficiency.

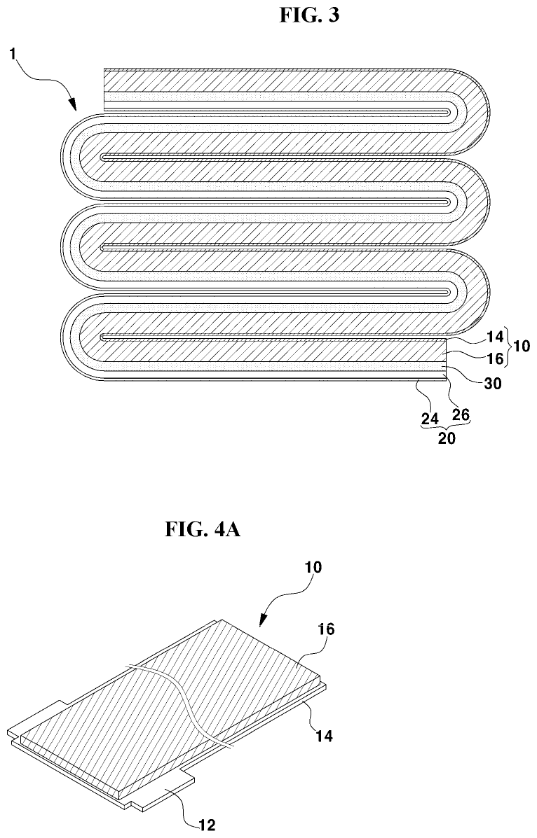

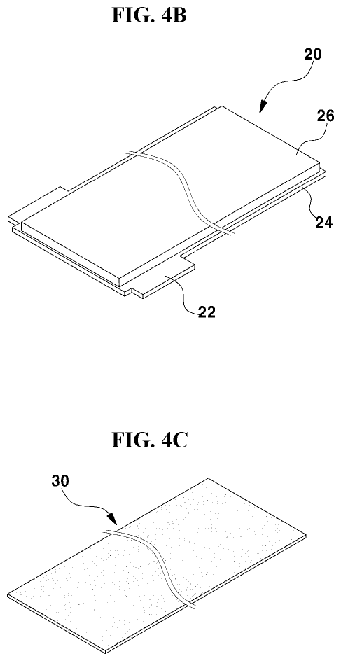

For this reason, the present disclosure aims to provide an apparatus for manufacturing an electrode assembly and a method of operating the same capable of facilitating manufacture of the electrode assembly through a simplified process and improving efficiency by minimizing a dead space. Specifically, as illustrated in FIG. 3, the present disclosure may solve the above described problems through an S-folding manufacturing method in which the positive electrode 10, the negative electrode 20, and the solid electrolyte 30 are stacked and integrated without cutting, and then the integrated body is folded into an “S” shape.

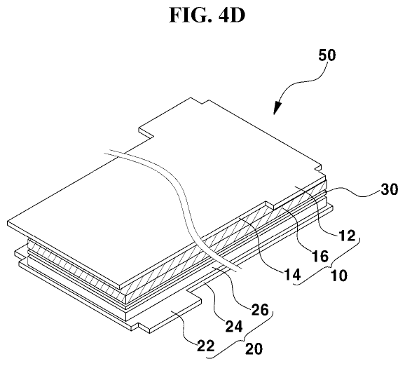

Referring to FIGS. 4A to 4D, in an electrode assembly 1 according to the present disclosure, a positive electrode 10, a negative electrode 20, and a solid electrolyte 30, all having a sheet shape, are stacked without a cutting process (e.g., the positive electrode 10, the negative electrode 20, and the solid electrolyte 30 are long sheets wound in the form of a roll). As illustrated in FIG. 4A, the positive electrode 10 having a sheet shape has a structure in which a positive electrode active material 16 is coated on a positive electrode current collector 14 including a positive electrode tab 12. As illustrated in FIG. 4B, the negative electrode 20 having a sheet shape has a structure in which a lithium-metal layer 26 is laminated on a negative electrode current collector 24 including a negative electrode tab 22. Then the solid electrolyte 30 is interposed between the positive electrode 10 and the negative electrode 20 to prepare an electrode assembly sheet 50 illustrated in FIG. 4D.

In this specification, the electrode assembly sheet 50 may be the electrode assembly 1 before being folded. In other words, in this specification, the electrode assembly sheet 50 may be in a state in which the positive electrode 10, the negative electrode 20, and the solid electrolyte 30 are joined together without cutting, but in a state before the electrode assembly 1 has the “S” shape. In distinction from the flat electrode assembly sheet 50, the electrode assembly 1 being folded may be referred to as an electrode assembly undergoing folding.

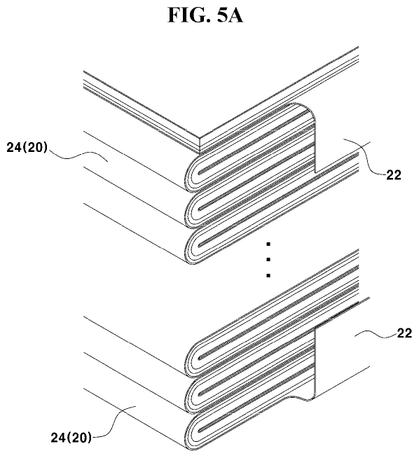

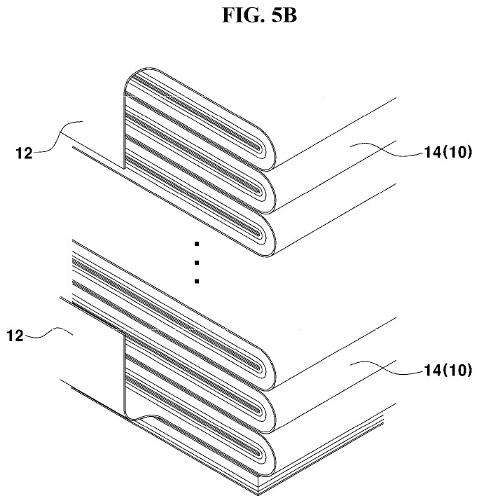

According to the present disclosure, the electrode assembly sheet 50 illustrated in FIG. 4D may go through the S-folding to become the electrode assembly 1 illustrated in FIG. 3 in which the folding process is completed. The positive electrode tab 12 and the negative electrode tab 12 of the electrode assembly 1 are to be welded to a positive electrode terminal and a negative electrode terminal, respectively. The positive electrode tab 12 and the negative electrode tab 12 is folded toward the electrode assembly 1 (FIGS. 5a and 5b), and the manufacture of the electrode assembly 1 is completed. Such S-folding may be performed automatically and at high speed by an apparatus 100 for manufacturing an electrode assembly according to an implementation of the present disclosure.

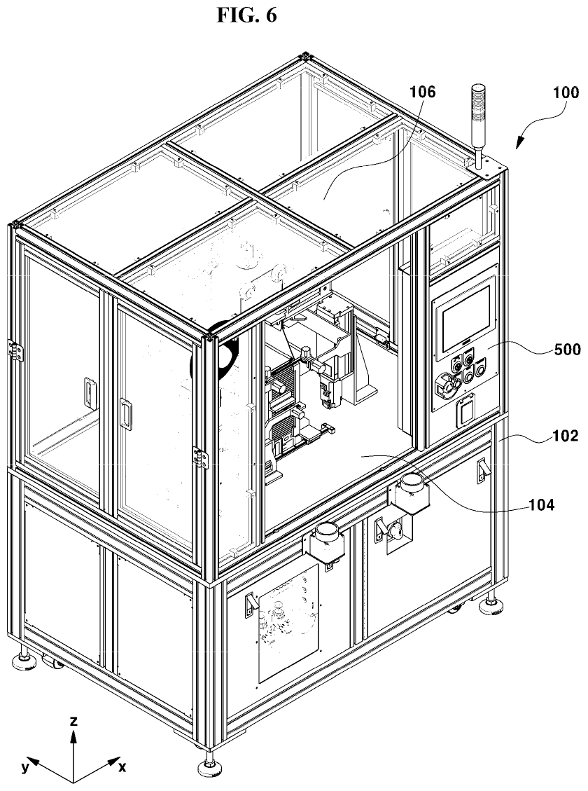

As illustrated in FIG. 6, the apparatus 100 for manufacturing an electrode assembly includes a frame 102 and a base 104. The frame 102 defines the skeleton of the apparatus 100 for manufacturing an electrode assembly. The base 104 is supported by the frame 102. The base 104 may be provided at a predetermined height in the frame 102 to facilitate worker access.

The base 104 supports a support structure 106. The support structure 106 is mounted with operating elements of the apparatus 100 for manufacturing an electrode assembly. In the drawings, the support structure 106 is illustrated as having a plate shape, but is not limited thereto and may have other shapes capable of supporting each of the operating elements.

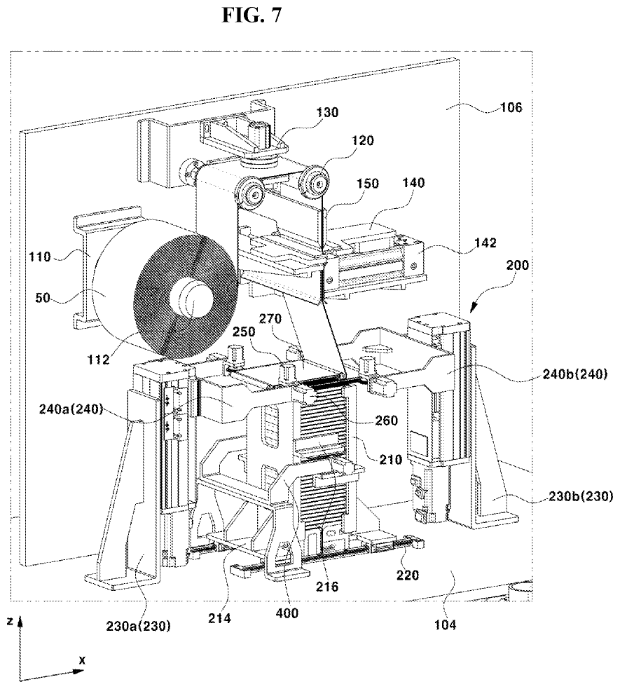

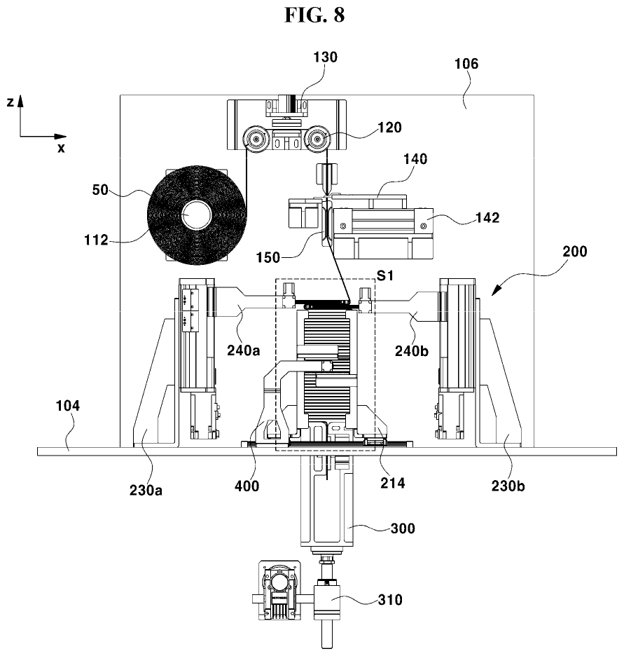

Referring to FIGS. 7 and 8, the electrode assembly sheet 50 is mounted on the support structure 106. The electrode assembly sheet 50, as described above, has a structure in which the positive electrode 10, the negative electrode 20, and the solid electrolyte 30 are assembled without cutting.

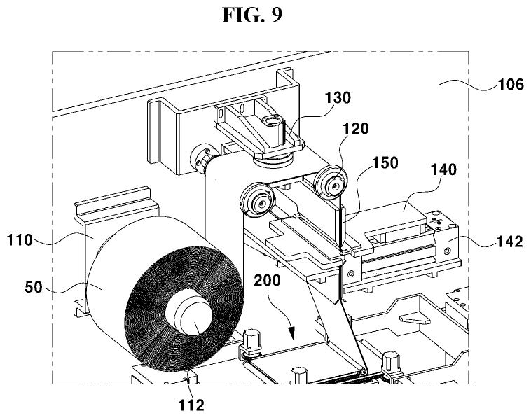

Additionally Referring to FIG. 9, the electrode assembly sheet 50 is mounted on a roll hanger 110 arranged in the support structure 106. The roll hanger 110 includes a rotatable sheet unwinder 112. The sheet unwinder 112 is rotatable with respect to the support structure 106 by an actuator, such as a motor. The electrode assembly sheet 50 having a roll shape may be unwound by the operation of the sheet unwinder 112.

A guide roller 120 is provided by a side of the roll hanger 110. The guide roller 120 may guide the flow of the electrode assembly sheet 50 being unwound. In an implementation, the guide roller 120 may be disposed above the roll hanger 110 in a vertical direction in a z-axis direction so that the electrode assembly sheet 50 being unwound may move higher than the roll hanger 110. In an implementation, at least two guide rollers 120 may be arranged. Two guide rollers 120 may be arranged to lie on a same line in a horizontal direction or in an x-axis direction. The electrode assembly sheet 50 may move on the two guide rollers 120 in the horizontal direction.

A helper gripper 130 is disposed beside the roll hanger 110. In an implementation, the helper gripper 130 may be disposed between the two guide rollers 120. The helper gripper 130 may serve to hold the electrode assembly sheet 50 to prevent dislocation of the electrode assembly sheet 50. The helper gripper 130 may release the grip on the electrode assembly sheet 50 when the electrode assembly sheet 50 is unwound from the roll hanger 110, whereas the helper gripper 130 may hold the electrode assembly sheet 50 when the electrode assembly sheet 50 is cut by a cutter unit 140, which is to be described later.

The electrode assembly sheet 50 passing through the guide roller 120 is disposed to pass through the cutter unit 140. The cutter unit 140 may operate at a predetermined time point to cut the electrode assembly sheet 50. The cutter unit 140 is provided with an actuator 142 so that the operation thereof is controlled by the actuator 142.

A guide element 150 may be arranged at opposing sides with respect to the cutter unit 140. The guide element 150 guides the movement of the electrode assembly sheet 50 passing through the guide roller 120 and allows the cutter unit 140 to accurately cut the electrode assembly sheet 50.

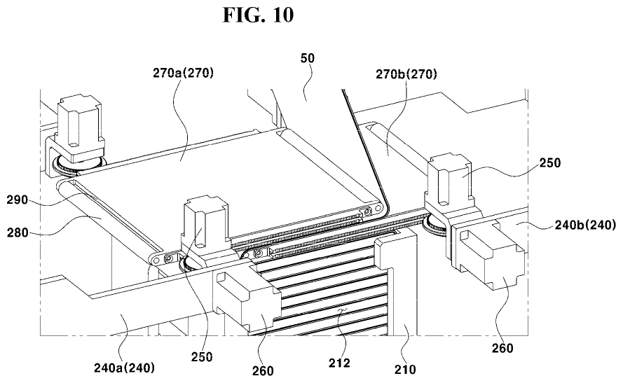

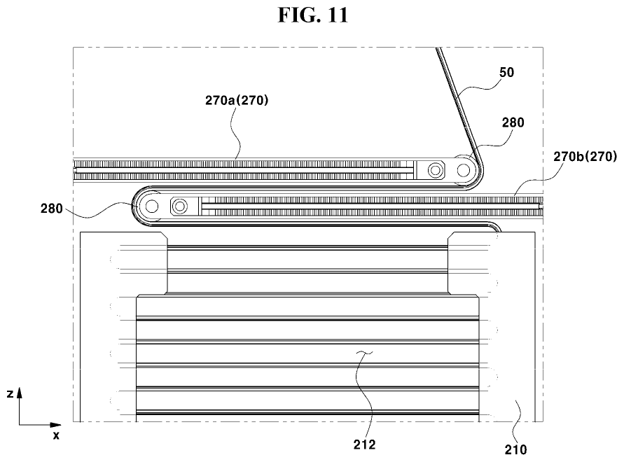

The base 104 is provided with a folding unit 200. As illustrated in FIGS. 10 and 11, the folding unit 200 may fold the electrode assembly sheet 50 supplied thereto to have the “S” shape.

The electrode assembly sheet 50 folded by the folding unit 200 is accommodated in a magazine 210 provided on the base 104. The magazine 210 accommodates therein the folded electrode assembly sheet 50 and includes an open portion 212. The open portion 212 that is at least a portion of the magazine 210 may directly communicate with the outside of the magazine 210.

The magazine 210 is supported by the base 104. The magazine 210 may be movable with respect to the base 104. For example, the magazine 210 may be movable in the x-axis direction. In an implementation, the base 104 may be provided with a rail 220, and the magazine 210 may have a leg 214 movable along the rail 220. The magazine 210 is movable with respect to the base 104 in association with the operation of an alignment unit 400, which is to be described later. The magazine 210 includes at least one fixture 216. The fixture 216 may be provided with a rack 218 including teeth. The fixture 216 may be disposed to overlap the electrode assembly sheet 50 folded in the magazine 210 through the open portion 212. The fixture 216 may align the folded electrode assembly sheet 50 by interworking with the alignment unit 400 to be described later.

The folding unit 200 includes a pair of stands 230. Each stand 230a, 230b is disposed at opposing side with respect to the magazine 210. For convenience of designation, any one of the pair of stands 230 will be referred to as a first stand 230a, and the other one of the pair of stands 230 will be referred to as a second stand 230b. Each of the stands 230a, 230b is equipped with an actuator, such as a linear actuator, a cylinder, and the like, and an arm member 240 movable by the actuator.

Each stand 230a, 230b is mounted with an arm member 240a, 240b, respectively. Here, the arm member 240a, 240b is connected to the stands 230a, 230b, respectively, to be movable in the vertical direction or in the z-axis direction. The moving force of the arm member 240 may be formed by the actuator provided in the stand 230. Here, for the purpose of distinction, the arm member mounted on the first stand 230a will be referred to as a first arm member 240a, and the arm member mounted on the second stand 230b will be referred to as a second arm member 240b.

The arm member 240 includes a folding guide 270. In other words, the first stand 230a includes a first folding guide 270a connected thereto by the first arm member 240a. The second stand 230b includes a second folding guide 270b connected thereto by the second arm member 240b. In an implementation, the first arm member 240a may include two arms, and the second arm member 240b may include two arms.

The folding guide 270 is configured to fold the electrode assembly sheet 50 into a predetermined size. In an implementation, the folding guide 270 may have a plate shape.

The folding guide 270 may be movable linearly and rotationally with respect to the arm member 240. In an implementation, the arm member 240 may be provided with a linear actuator 250 and a rotary actuator 260. The folding guide 270 may be linearly moved in a direction substantially parallel to the arm member 240 or in the x-axis direction by the operation of the linear actuator 250. In addition, the folding guide 270 may be rotatable with respect to the arm member 240 by the operation of the rotary actuator 260.

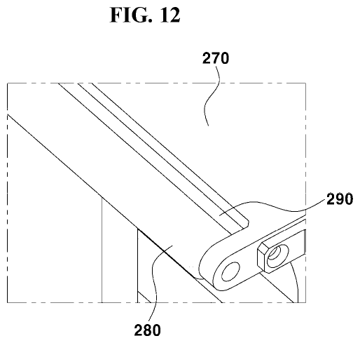

Referring to FIG. 12, the folding guide 270 includes a rolling element 280. The rolling element 280 may prevent damage to the electrode assembly sheet 50 when the folding guide 270 folds the electrode assembly sheet 50. In addition, the folding guide 270 includes a brush member 290 configured to clean the rolling element 280. The brush member 290 may clean the rolling element 280 at all times to keep the rolling element 280 clean, thereby preventing contamination of and damage to the electrode assembly sheet 50.

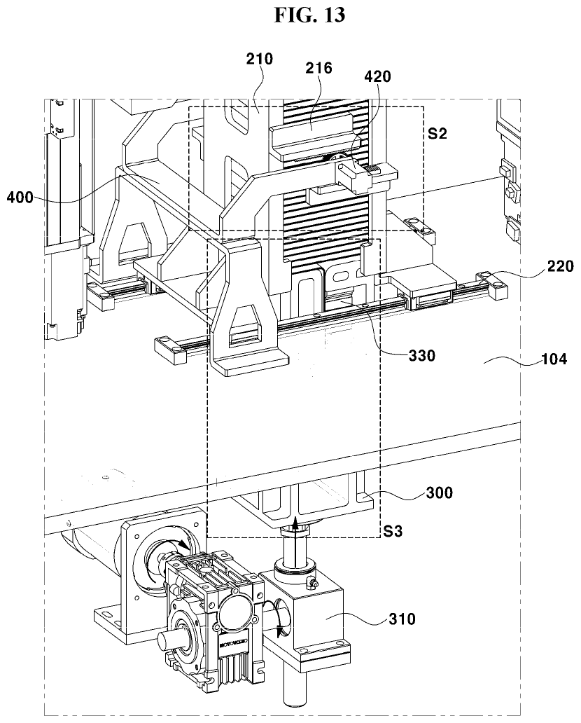

Referring to FIG. 13, the folding unit 200 may further include a pressing unit 300 and the alignment unit 400. The pressing unit 300 may continuously and repeatedly compress the electrode assembly sheet 50 being folded The alignment unit 400 may maintain the alignment of the electrode assembly 1 undergoing folding.

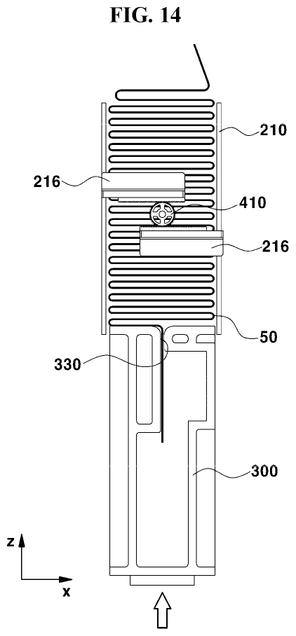

Additionally Referring to FIG. 14 (51 in FIG. 8), the pressing unit 300 may press the electrode assembly 1 undergoing folding. In an implementation, the pressing unit 300 may be disposed under the base 104. The pressing unit 300 may press the folded electrode assembly sheet 50 in the magazine 210 while moving upwards or in the z-axis direction by passing through the base 104. The base 104 may be provided with a pressing unit actuator 310 configured to operate the pressing unit 300.

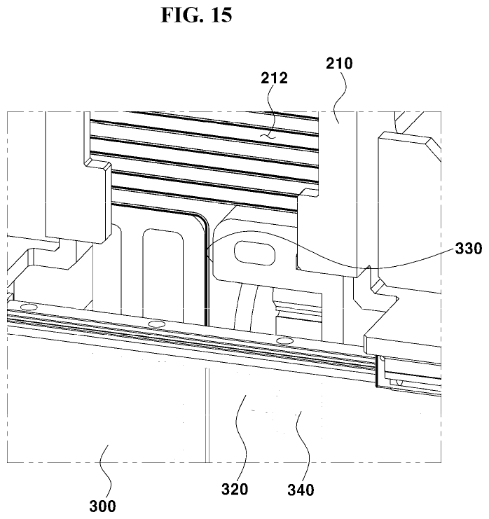

Referring to FIG. 15, the pressing unit 300 may include a gripper 320. The pressing unit 300 has formed therein a gap 330. The gap 330 allows the end portion of the electrode assembly sheet 50 to be inserted therein when the electrode assembly sheet 50 starts to be folded. The gripper 320 neighbors the gap 330. The gripper 320 may grip the end portion of the electrode assembly sheet 50 to prevent dislocation of the electrode assembly sheet 50 during the folding process. During the folding process, the end portion of the electrode assembly sheet 50 is gripped by the gripper 320. Then when folding is completed, the gripper 320 releases the grip to discharge the electrode assembly sheet 50. In an implementation, the gripper 320 may be provided with a gripper actuator 340 configured to provide gripping force to the gripper 320 and release the grip of the gripper 320.

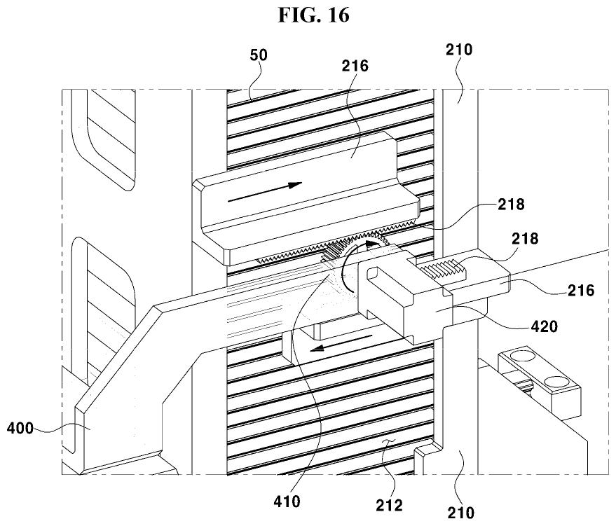

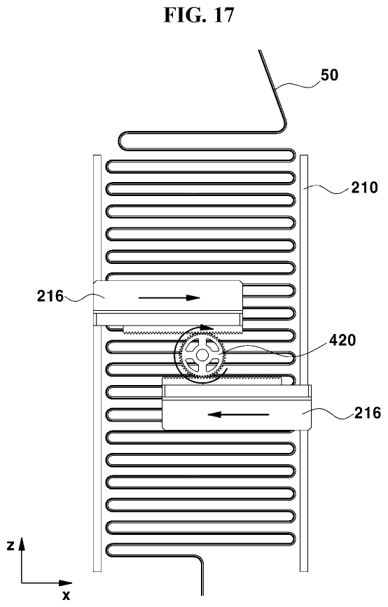

As illustrated in FIGS. 16 and 17, the alignment unit 400 performs an operation to maintain the alignment of the electrode assembly sheet 50 being compressed during the folding process. One alignment unit 400 may be provided at opposing sides of the folded electrode assembly sheet 50.

The alignment unit 400 may have one end supported by the base 104. The alignment unit 400 may have another end provided with a pinion actuator 420 configured to operate a pinion gear 410. The pinion gear 410 may mesh with the rack 218 of the fixture 216, and the magazine 210 may move relative to the alignment unit 400 by the operation of the pinion gear 410.

The pinion gear 410 may be brought into contact with the folded electrode assembly sheet 50 through the open portion 212 in the magazine 210. The pinion gear 410 may be provided at opposite sides of the magazine 210 and may help the folded electrode assembly sheet 50 maintain the alignment by aligning the electrode assembly sheet 50 being folded.

The apparatus 100 for manufacturing the electrode assembly includes a controller 500. The controller 500 may control and supervise the operation of the apparatus 100 for manufacturing an electrode assembly. In an implementation, the controller 500 may be mounted on the frame 102 in the form of a panel to communicate with a worker.

The operation of the apparatus 100 for manufacturing an electrode assembly according to the present disclosure will be described as follows.

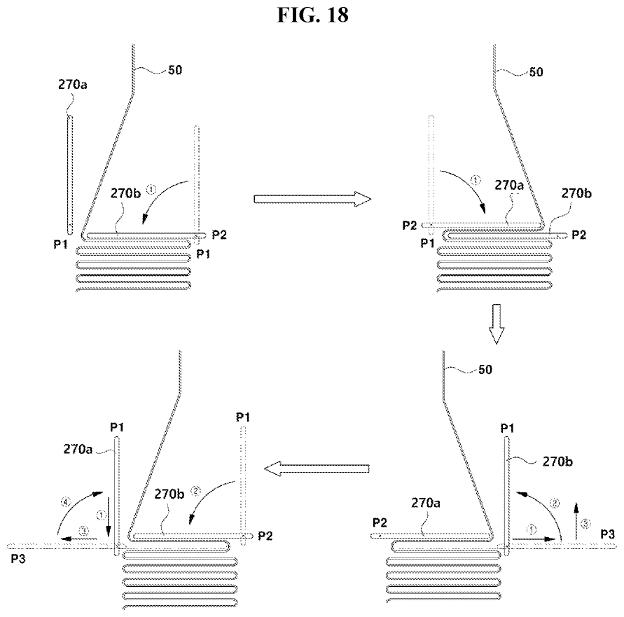

As in FIG. 18, assuming that it is time for the second folding guide 270b to operate, the second folding guide 270b being upright or parallel to the z-axis direction rotates from an upright position P1 to a folding position P2. Thereafter, the first folding guide 270a being upright rotates toward the magazine 210 to stack the electrode assembly sheet 50 supplied from the roll hanger 110. In this process, the first folding guide 270a moves from the upright position P1 to the folding position P2, and the first folding guide 270a is disposed above the second folding guide 270 with the electrode assembly sheet 50 interposed therebetween. During the folding process, the first arm member 240a and the second arm member 240b move up or down in the z-axis direction to continuously stack the electrode assembly sheet 50.

Next, it is again the turn of the second folding guide 270b to stack the electrode assembly sheet 50. The second folding guide 270b inside the electrode assembly sheet 50 is retracted in the x-axis direction and placed between the second arm members 240b (retracted position P3). Then the second folding guide 270b rotates to move back to the upright position P1 and rotates toward the electrode assembly sheet 50. In addition, the first folding guide 270a operates in a similar manner to the second folding guide 270b, allowing the electrode assembly sheet 50 being supplied to continue to be folded.

According to the present disclosure, the electrode assembly may be manufactured only by two unit processes, which are the process of laminating the electrode and the solid electrolyte and the process of folding the electrode assembly sheet.

In addition, according to the present disclosure, a high-speed process may be realized, while minimizing damage such as cracks to the electrodes and preventing scratches on the current collector layers. Particularly, according to the present disclosure, because the folding guide does not change position once folded, cracks or scratches on the electrode assembly sheet may be prevented.

As is apparent from the above description, the present disclosure provides the following effects.

The present disclosure provides an apparatus for manufacturing an electrode assembly and a method of operating the same that is simplified by reducing the number of processes.

The present disclosure provides an apparatus for manufacturing an electrode assembly and a method of operating the same capable of manufacturing the electrode assembly at high speed without damaging an electrode or a solid electrolyte.

Effects of the present disclosure are not limited to the ones described above, and other effects not mentioned herein will be clearly recognized by those skilled in the art based on the above description.

It will be apparent to those of ordinary skill in the art to which the present disclosure pertains that the present disclosure described above is not limited by the above-described implementations and the accompanying drawings, and various substitutions, modifications and changes are possible within a range that does not depart from the technical idea of the present disclosure.

What is claimed is:

1. An apparatus for manufacturing an electrode assembly, the apparatus comprising:
a folding unit comprising a pair of folding guides facing each other,
wherein the folding guides are configured to alternately fold an electrode assembly sheet being continuously supplied to thereby form an electrode stack having a predetermined size.

2. The apparatus according to claim 1, wherein the folding unit further comprises:
a magazine configured to fix an end portion of the electrode assembly sheet and accommodate therein the electrode assembly sheet that is folded;
a first folding guide disposed at a first side of the magazine and movable and rotatable with respect to the magazine; and
a second folding guide disposed at a second side of the magazine and movable and rotatable with respect to the magazine.

3. The apparatus according to claim 2, wherein each of the first folding guide and the second folding guide are configured to be put in:
an upright position disposed along a z-axis direction;
a folding position disposed on the electrode assembly sheet folded in an x-axis direction; and
a retracted position retracted in the x-axis direction from the folding position,
wherein the first folding guide and the second folding guide are configured to move between upright position, the folding position, and the retracted position to fold the electrode assembly sheet.

4. The apparatus according to claim 2, comprising:
a first arm member movable in a stack direction of the electrode assembly sheet and rotatably and movably mounting the first folding guide; and
a second arm member movable in the stack direction of the electrode assembly sheet and rotatably and movably mounting the second folding guide.

5. The apparatus according to claim 2, wherein each of the first folding guide and the second folding guide comprises a rolling element at an end portion thereof.

6. The apparatus according to claim 5, wherein each of the first folding guide and the second folding guide further comprises a brush member configured to clean the rolling element.

7. The apparatus according to claim 2, further comprising a pressing unit configured to fix the end portion of the electrode assembly sheet and to be movable within the magazine.

8. The apparatus according to claim 7, wherein the pressing unit comprises:
a gap that is defined to accommodate the end portion of the electrode assembly sheet; and
a gripper configured to grip the end portion of the electrode assembly sheet disposed in the gap.

9. The apparatus according to claim 2, further comprising an alignment unit configured to align the folded electrode assembly sheet through an open portion, wherein the magazine defines the open portion through which the folded electrode assembly sheet is accessible.

10. The apparatus according to claim 9, wherein:
the alignment unit comprises a rotatable pinion gear configured to be brought into contact with the folded electrode assembly sheet through the open portion, and
the magazine comprises a rack configured to move by meshing with the pinion gear.

11. The apparatus according to claim 10, wherein the alignment unit is fixed, and the magazine is movable on a rail.

12. The apparatus according to claim 1, wherein the electrode assembly sheet comprises:
a positive electrode comprising a positive electrode active material and a positive electrode current collector;
a negative electrode laminated on the positive electrode and comprising a negative electrode active material and a negative electrode current collector; and
a solid electrolyte interposed between the positive electrode and the negative electrode.

13. The apparatus according to claim 12, wherein the negative electrode active material comprises a lithium-metal layer.

14. The apparatus according to claim 2, further comprising:
a roll hanger configured to unwind the electrode assembly sheet; and
a guide roller configured to guide the unwound electrode assembly sheet to the folding unit.

15. The apparatus according to claim 14, further comprising a helper gripper configured to grip the electrode assembly sheet unwound from the roll hanger.

16. The apparatus according to claim 14, further comprising a cutter unit disposed between the roll hanger and the folding unit and configured to cut the electrode assembly sheet.

17. A method of manufacturing an electrode assembly, the method comprising:
rotating a first folding guide and a second folding guide parallel to a z-axis direction;
rotating the first folding guide towards an electrode assembly sheet supplied in the z-axis direction until the first folding guide is parallel to an x-axis direction to fold the electrode assembly sheet;
moving the second folding guide above the first folding guide in the z-axis direction; and
rotating the second folding guide toward the electrode assembly sheet until the second folding guide is parallel to the x-axis direction to fold the electrode assembly sheet.

18. The method according to claim 17, further comprising:
retracting the first folding guide from the folded electrode assembly sheet in the x-axis direction;
rotating the retracted first folding guide parallel to the z-axis direction; and
rotating the first folding guide toward the electrode assembly sheet until the first folding guide is parallel to the x-axis direction to fold the electrode assembly sheet.
